(19) United States
(12) Patent Application Publication
(10) Pub. No.: US 2025/0058289 A1
(43) Pub. Date: Feb. 20, 2025

(54) MIXING DEVICE AND METHOD

(71) Applicant: Tetra Laval Holdings & Finance S.A., Pully (CH)

(72) Inventors: Thomas EGGLER, Rothrist (CH); Denis STEFFEN, Gränichen (CH); Nora MAGONI, Gretzenbach (CH); Sergio ZAPPELLA, Bergamo (IT)

(73) Assignee: Tetra Laval Holdings & Finance S.A., Pully (CH)

(21) Appl. No.: 18/724,242

(22) PCT Filed: Dec. 15, 2022
(86) PCT No.: PCT/EP2022/086015

§ 371 Date: Jun. 26, 2024

(30) Foreign Application Priority Data
Dec. 30, 2021 (EP) 21218419.6

(51) Int. Cl. B01F 25/452; B01F 23/50; B01F 25/31; B01F 35/10; B01F 101/06

(52) U.S. Cl. CPC B01F 25/45212; B01F 23/50; B01F 25/31; B01F 25/45211; B01F 35/1452; B01F 2101/06

(57) ABSTRACT

A mixing device for mixing a powder-liquid mixture, comprises a movable body, arranged within the housing, with a channel formed between the housing and the movable body. An actuator moves the movable body between a closed and an opened position. The movable body comprises a first body section having a first set of openings, and a second body section having a second set of openings. The housing comprises a sleeve with a covering section that covers the second set of openings when the movable body is in the closed position, for minimizing a flow of the mixture through the second set of openings, and be offset from the second set of openings when the movable body is in the open position, for allowing the mixture to flow into the channel through the second set of openings.

### TECHNICAL FIELD

The invention relates to a mixing device for mixing a powder and a liquid. The mixing device has a movable body arranged to move between a closed position and an open position, where the open position allows for better mixing while the closed position allows for improved cleaning.

### BACKGROUND ART

Today it is common in many processes in the food industry to mix a powder substance with a liquid substance. The powder substance may be, e.g. milk powder, sugar, a stabilizer, a thickener or a gum, or any other substance that shall be mixed with a liquid. The liquid may be water, liquid dairy products, sugar solutions or other water-based liquid mixtures. Some powders may be difficult to wet and to dissolve in liquid, making it hard to obtain an even mixture, for example because lumps or fisheyes are formed in the mixture. There is a huge number of liquid substances into which another substance, sometimes referred to as a second substance, is commonly mixed so that a food product is obtained.

In order to mix a powder with a liquid, a Venturi type effect is often used in the food industry. As is well known, the Venturi effect is the reduction in fluid pressure that results when a liquid flows through a constricted section of a fluid conduit. The reduction in pressure, caused by the flow of the liquid, is used to draw a powder into the liquid. The drawing of the powder into the liquid effects mixing, since the liquid and the substance obviously are combined and thereafter leave the apparatus as one common liquid stream, there by forming a mixture. The mixing apparatus is sometimes referred to as an injector, or as a suction device since it creates a relatively lower pressure that “sucks in” the powder into the liquid.

Even though existing mixing devices such as injectors and other types of mixing units are capable of efficiently mixing liquids and powders, there is still a problem with accomplishing even and homogenous mixing, in particular when the powder is of a type that tends to form lumps in the liquid. At the same time as mixing shall be efficiently accomplished, the mixing devices must also have a sanitary design, which should preferably be easy to clean.

### SUMMARY

It is an object of the invention to at least partly overcome one or more of the above-identified limitations of the prior art. In particular, it is an object to further improve the mixing of powders, such as stabilizers, thickeners or gums, that are usually hard to mix with liquids. Another objective is to provide a mixing apparatus that is easy to clean.

According to a first aspect a mixing device for mixing a powder-liquid mixture is provided. The mixing devices comprises a housing with an inlet and an outlet, a movable body arranged within the housing with a channel formed between the housing and the movable body and leading to the outlet of the mixing device, an actuator that moves the movable body within the housing, between a closed position and an open position. The movable body of the mixing device comprises a body inlet that is aligned with the inlet of the housing and leading to the interior space, a first body section forming a first part of the interior space and having a first set of openings leading to the channel, and a second body section forming a second part of the interior space and having a second set of openings leading to the channel. The housing of the mixing device comprises a sleeve having a covering section that is arranged to cover the second set of openings when the movable body is in the closed position, for minimizing a flow of the mixture through the second set of openings, and be offset from the second set of openings when the movable body is in the open position, for allowing the mixture or a cleaning liquid to flow through the second set of openings and into the channel.

Having two positions for the movable body of the mixing device it is advantageous as it allows for two operation modes, one where mixing is efficiently accomplished and one where cleaning is efficiently performed.

The movable body may be a linearly movable body. The linear movement of the body may accomplish the movement between the closed position and the open position. The actuator may be arranged to move the movable body in a linear direction within the housing. Herein, a linear direction is a direction along a straight line, and may therefore be described mathematically using only one spatial dimension. Linearly movable may be defined as being capable to move along a straight line that extends in one spatial dimension. Additionally or alternatively, it is possible to arrange the movable body to move with a rotational movement. The rotational movement may be defined as a circular movement of the body around a central axis of the body. The central axis may be parallel to or defined by the linear direction in which the movable body is arranged to move.

The sleeve of the mixing device of the present invention may be arranged at the inlet of the housing and may extend into the housing of the mixing device

The sleeve of the mixing device may be at least partly located at a position between the body inlet of the movable body and the first body section of the mixing device.

The sleeve of the mixing device may have through holes that are offset from the second set of openings when the movable body is in the closed position, and aligned with the second set of openings when the movable body is in the open position. When the movable body is in the open position, that is when the through holes of the sleeve are aligned with the second set of openings, allowing a cleaning liquid to pass through the movable body for efficient cleaning of the mixing device.

The sleeve of the mixing may have a support section for supporting the movable body inside the housing. The movable body of the mixing device may comprise a body inlet section forming the inlet of the movable body, and the second set of openings may be located between the support section and the first set of openings.

The movable body of the mixing device may comprise a third body section forming an end part of the interior space and having a third set of openings. This third set of openings allows the mixture or a cleaning liquid to flow through the third set of openings and into the channel of the mixing device when the movable body is in the open position.

The housing of the mixing device may comprise an end section that is arranged to cover the third set of openings when the movable body is in the closed position, for minimizing a flow of the mixture through the third set of openings.

The actuator of the mixing device may comprise a rod extending through the housing and connected to the third body section of the movable body.

The first set of openings of the mixing device may comprise individual openings, where each individual opening of the first set of openings has a size in the range from 0.3 mm to 1.5 mm. The second set of openings of the mixing device comprises individual openings, each individual opening of the second set of openings having a size at least five times bigger than the individual openings of the first set of openings.

According to a second aspect a mixing system is provided. The system comprises a mixing device according to the first aspect, a pump, a hopper and an injector. The pump and the hopper are connected to the injector for feeding liquid respectively powder into the injector to form a powder-liquid mixture. The injector is connected to the mixing device for feeding the powder-liquid mixture through the mixing device to form a mixed powder-liquid mixture.

According to a third aspect a method of operating a mixing device according to the first aspect is provided. Preferably the method is performed for operating a mixing device to mix a food product mixture, i.e. the powder-liquid mixture may be a food product mixture that shall be used for consumption by humans. The method comprises closing the mixing device by setting the movable body in the closed position, feeding a powder-liquid mixture through the mixing device such that it forms a mixed powder-liquid mixture, opening the mixing device by setting the movable body is in the open position, and feeding a cleaning liquid through the mixing device.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a schematic view of a mixing device,

FIG. 2 is a schematic view of a mixing system that includes the mixing device,

FIG. 3 is a cross-sectional perspective view of the mixing device, when set in a closed position,

FIG. 4 is a cross-sectional side view of the mixing device, when set in a closed position,

FIG. 5 is a cross-sectional perspective view of the mixing device, when set in an open position,

FIG. 6 is a cross-sectional side view of the mixing device, when set in an open position, and

FIG. 7 is a flow chart of a method of operating the mixing device.

### DETAILED DESCRIPTION

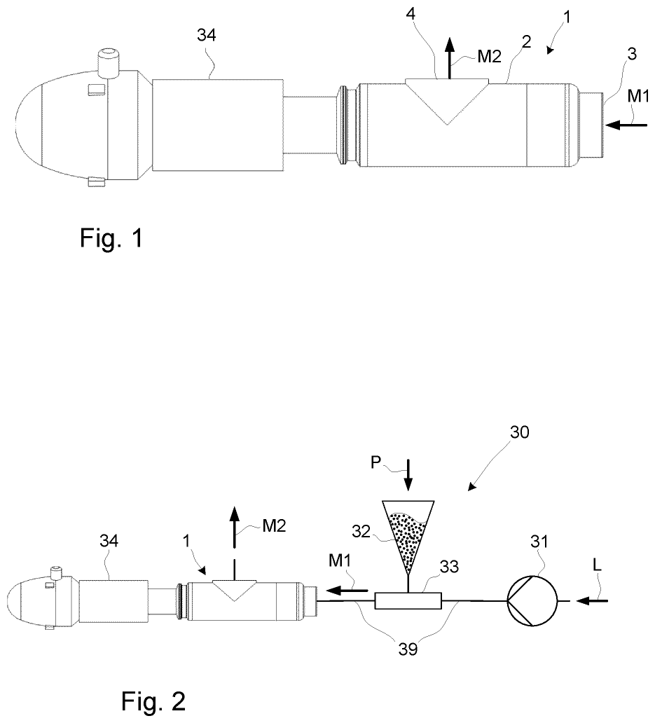

With reference to FIG. 1 a mixing device 1 having an actuator 34 is illustrated. The mixing device 1 has a housing 2 with an inlet 3 that is arranged to receive a powder-liquid mixture M1. The powder-liquid mixture M1 is mixed inside the mixing device 1 to form a mixed powder-liquid mixture M2, which exits the mixing device 1 through an outlet 4. The inlet 3 and the outlet 4 of the mixing device 1 can be arranged in perpendicular directions relative to each other. The mixed powder-liquid mixture M2 leaving the mixing device 1 is, in comparison to the powder-liquid mixture M1, better mixed than the powder-liquid mixture M1 that enters the mixing device 1. Both mixtures contain the same powder and liquid, it is just the level is mixing that differs.

With reference to FIG. 2 a mixing system 30 is illustrated. The mixing system 30 includes the mixing device 1 as well as a pump 31, a hopper 32 and an injector 33. The pump 31 is via a fluid line 39 connected to a liquid inlet of the injector 33 and the hopper 32 is connected to a powder inlet of the injector 33 for feeding powder P into the injector 33. Both the pump 31, the hopper 32 and the injector 33 are conventional units that are commonly used in the food industry for mixing powder P with liquid L.

The pump 31 is arranged to feed the liquid L into the injector 33 such that the injector 33 draws the power P into a mixing chamber of the injector 33. The liquid L and the powder P are mixed in the mixing chamber to form the powder-liquid mixture M1 which is then, via the fluid line 39, fed to the mixing device 1. As described, the powder-liquid mixture M1 is thereafter mixed inside the mixing device 1 to form a mixed powder-liquid mixture M2.

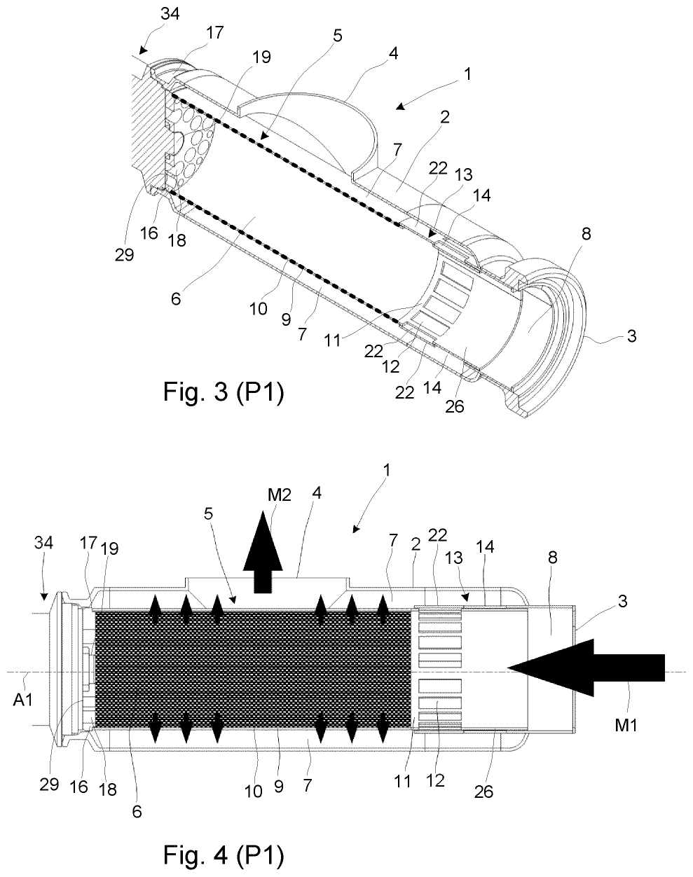

With reference to FIG. 3 and FIG. 4, showing the mixing device 1 in a closed position P1, a movable body 5 is arranged inside the housing 2 and has an interior space 6. In FIG. 4 a flange at the inlet 3 is omitted. The movable body 5 has a smaller dimension than the housing 2, allowing for a channel 7 to be formed between the housing 2 and the movable body 5. The movable body 5 has a cylindrical shape and the channel 7 extends around the cylindrically shaped body 5 and is fluidly connected to the outlet 4.

The movable body 5 has a body inlet 26 that is aligned with the inlet 3 of the housing 2 and leads to the interior space 6 of the movable body 5. Thus, when powder-liquid mixture M1 enters the inlet 3 of the housing 3, it also enters the inlet 26 of the movable body 5. The movable body 5 has a first body section 9 that forms a first part of the interior space 6, i.e. the first body section 9 forms the boundaries of a part of the interior space 6. The first body section 9 has a set of openings 10 that lead to the channel 7. This allows powder-liquid mixture M1 to flow from the interior space 6, through the set of openings 10 and into the channel 7, enabling the powder-liquid mixture M1 to leave the mixing device 1 via the opening 4. When the powder-liquid mixture M1 passes the openings 10 in the first body section 9 it is subjected to shear forces that causes the powder-liquid mixture M1 to mix even further, such that it thereby forms a mixed powder-liquid mixture M2. The first set of openings 10 comprises many individual openings and may have the form of a mesh. The first set of openings 10 may also be openings that are drilled or punched as holes in the first body section 9. Each individual opening of the first set of openings 10 may have a size in the range from 0.3 mm to 1.5 mm.

The movable body 5 has a second body section 11 that forms a second part of the interior space 6 and has a second set of openings 12 leading to the channel 7. The second body section 11 is closer to the inlet 3 than the first body section 9. The second set of openings 12 comprises individual openings. These individual openings have a respective size that is at least five times bigger than the individual openings of the first set of openings 10.

The housing 2 has a sleeve 13 which includes a covering section 22 that is arranged to cover the second set of openings 12 when the movable body 5 is in a closed position P1. This minimizes a flow of the mixture M1 through the second set of openings 12. The covering section 22 is arranged to be offset from the second set of openings 12 when the movable body 5 is in an open position P2. The sleeve 13 has through holes 14 that then are aligned with the second set of openings 12 of the movable body 5. This allows the mixture powder-liquid mixture M1, or any other mixture for that matter such as a cleaning liquid, to easily flow into the channel 7 via the second set of openings 12. The actuator 34 is connected to the movable body 5 and is arranged to move the movable body 5 within the housing 1, between the closed position P1 and the open position P2.

The sleeve 13 is arranged at the inlet 3 of the housing 2 and extends into the housing 2 of the mixing device 1. The sleeve 13 is located at a position between the inlet 3 of the housing 2 and the first body section 9, and has a cylindrically shaped section 8 that supports the movable body 5. In other words, the sleeve 13 is supporting the movable body 5 inside the housing 2. The sleeve 13 is fixedly connected to the housing 2. The movable body 5 has a cylindrically shaped body inlet section 26 that forms the inlet of the movable body 5. As can be seen from the figures, the second set of openings 12 are located at a position between the support section 8 and the first set of openings 10.

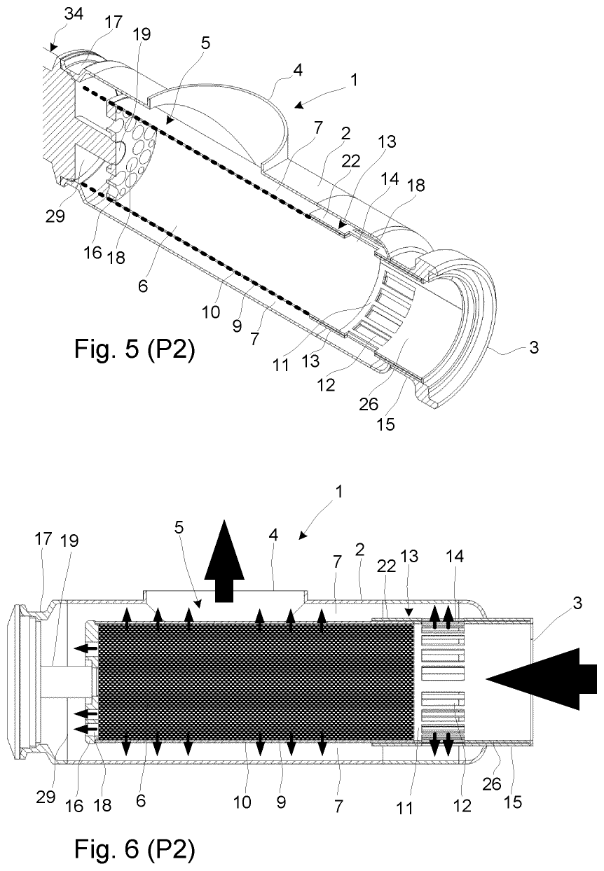

With further reference to FIG. 5 and FIG. 6, showing the mixing device 1 in an open position P2, the through holes 14 of the sleeve 13 are aligned with the second set of openings 12 when the movable body 5 is in the open position P2. In FIG. 6 a flange at the inlet 3 is omitted.

As can be seen in FIG. 3 and FIG. 4, the through holes 14 of the sleeve 13 are offset from the second set of openings 12 when the movable body 5 is in the closed position P1. In the closed position P1, the through holes 14 of the sleeve 13 are instead aligned with the body inlet section 26 of the movable body 5, such that the through holes 14 of the sleeve 13 are closed.

The movable body 5 has a third body section 16 that forms an end part 17 or end plate of the interior space 6. The third body section 16 has a third set of openings 18 that allows the mixture M1 or, for example, a cleaning liquid to flow through the third set of openings 18 and into the channel 7 when the movable body 5 is in the open position P2. The housing 2 has an end section 29 that covers the third set of openings 18 when the movable body 5 is in the closed position P1. This minimizes a flow of the mixture M1 through the third set of openings 18. In the closed position P1 the third body section 16 of the movable body 5 abuts the housing end section 29, which effectively covers the third set of openings 18.

For moving the movable body 5 between the open and closed positions P1, P2 the actuator 34 has a rod 19 that extends through the housing 2 and is connected to the third body section 16. The actuator 34, which can be any suitable conventional actuator, can then be operated to open and close the mixing device 1, i.e. move the movable body 5 between the open and closed positions P1, P2.

The body 5 may be linearly movable along a main axis A1 of the body 5. The actuator 34 may be a linear actuator capable to move the body 5 in a linear direction within the housing 2. The linear direction may correspond to the central axis A1. The central axis A1 may be the straight segment of (a straight line within) the cylindrically shaped section 8 which contains the centers of the two bases of the cylindrically shaped section 8.

The actuator 34 may, alternatively or additionally, be a rotational actuator, such that the movable body 5 may be configured to move with a rotational movement. The rotational movement may be defined as a circular movement of the body 5 around its main axis A1.

When the movable body 5 is in the closed position P1 nearly all powder-liquid mixture M1 is forced through the small openings of the first body section 9, which provides efficient mixing. When the movable body 5 is in the open position P2 much more of the powder-liquid mixture M1 passes through the second set of openings 12 and the third set of openings 18. Using the open position P2 is advantageous when, for example, liquid and powder are sufficiently mixed before entering the mixing device 1, making it unnecessary to pass the mixture through the first set of openings 10. The mixture then can pass the mixing device 1 at a relatively smaller pressure drop over the mixing device 1. The open position P2 may advantageously also be used when cleaning the mixing device 1, since cleaning liquid can then access parts of the mixing device 1 which otherwise would be hard to clean. During cleaning the mixing device 1 may be alternately switched between the open and closed positions P1, P2 a number of times. FIG. 4 and FIG. 6 illustrates with black arrows the flows through the mixing device 1 in the open respectively the closed position P1, P2.

The mixing device 1 is preferably made of stainless steel and manufactured by using conventional production techniques.

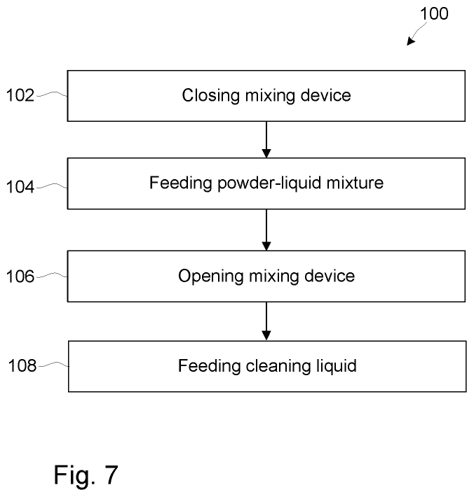

With reference to FIG. 7 a method 100 of operating the mixing device 1 is described. According to the method, the mixing device 1 is closed 102 by setting the movable body 5 in the closed position P1. When the mixing device 1 is in the closed position P1, powder-liquid mixture M1 is fed 104 through the mixing device 1, thus forming a mixed powder-liquid mixture (M2). Next the mixing device 1 is opened 106 by setting the movable body 5 in the opened position P2. Thereafter a cleaning liquid is fed 108 through the mixing device 1, thus cleaning the mixing device 1. Preferably, the method comprises operating the mixing device 1 for mixing a food product powder with a liquid for forming a mixed powder-liquid mixture M2 that is either a food product or forms part of a food product.

From the description above follows that, although various embodiments of the invention have been described and shown, the invention is not restricted thereto, but may also be embodied in other ways within the scope of the subject-matter defined in the following claims.

1. A mixing device for mixing a powder-liquid mixture, the mixing device comprising a housing having an inlet and an outlet, a movable body having an interior space and arranged within the housing, with a channel formed between the housing and the movable body and leading to the outlet, and an actuator arranged to move the movable body within the housing, between a closed position and an open position,
the movable body comprising a body inlet aligned with the inlet of the housing and leading to the interior space, a first body section forming a first part of the interior space and having a first set of openings leading to the channel, and a second body section forming a second part of the interior space and having a second set of openings leading to the channel, wherein
the housing comprises a sleeve having a covering section arranged to
cover the second set of openings when the movable body is in the closed position, for minimizing a flow of the mixture through the second set of openings, and
be offset from the second set of openings when the movable body is in the open position, for allowing the mixture or a cleaning liquid to flow through the second set of openings and into the channel.

2. The mixing device according to claim 1, wherein the sleeve is arranged at the inlet of the housing and extends into the housing of the mixing device.

3. The mixing device according to claim 1, wherein the sleeve is at least partly located at a position between the body inlet of the movable body and the first body section.

4. The mixing device according to claim 1, wherein the sleeve has through holes that are
offset from the second set of openings when the movable body is in the closed position, and
aligned with the second set of openings when the movable body is in the open position.

5. The mixing device according to claim 1, wherein the sleeve comprises a support section for supporting the movable body inside the housing.

6. The mixing device according to claim 1, wherein the movable body comprises a body inlet section forming the inlet of the movable body, the second set of openings being located at a position between the support section and the first set of openings.

7. The mixing device according to claim 1, wherein the movable body comprises a third body section forming an end part of the interior space and having a third set of openings for allowing the mixture or a cleaning liquid to flow through the third set of openings and into the channel when the movable body is in the open position.

8. The mixing device according to claim 7, wherein the housing comprises an end section that is arranged to cover the third set of openings when the movable body is in the closed position, for minimizing a flow of the mixture through the third set of openings.

9. The mixing device according to claim 7, wherein the actuator comprises a rod extending through the housing and connected to the third body section of the movable body.

10. The mixing device according to claim 1, wherein the first set of openings comprises individual openings, each individual opening of the first set of openings having a size in the range from 0.3 mm to 1.5 mm.

11. The mixing device according to claim 1, wherein the second set of openings comprises individual openings, each individual opening of the second set of openings having a size at least five times bigger than the individual openings of the first set of openings.

12. A mixing system comprising
a mixing device according to claim 1,
a pump, a hopper and an injector, wherein
the pump and the hopper are connected to the injector for feeding liquid respectively powder into the injector to form a powder-liquid mixture, and
the injector is connected to the mixing device for feeding the powder-liquid mixture through the mixing device to form a mixed powder-liquid mixture.

13. A method of operating a mixing device according to claim 1, the method comprising
closing the mixing device by setting the movable body in the closed position,
feeding a powder-liquid mixture through the mixing device such that it forms a mixed powder-liquid mixture,
opening the mixing device by setting the movable body is in the open position, and
feeding a cleaning liquid through the mixing device.
